(19) United States
(12) Patent Application Publication
(10) Pub. No.: US 2006/0287020 A1
(43) Pub. Date: Dec. 21, 2006

(54) Concave lifting device

(76) Inventor: Blaine Muhr, Francis (CA)

Correspondence Address: Ade & Company Inc., 1795 Henderson Highway, PO Box 28006, Winnipeg, Manitoba, R2G 4E9, CA

(21) Appl. No.: 11/445,283

(22) Filed: Jun. 2, 2006

Related U.S. Application Data
(60) Provisional application No. 60/651,497, filed on Jun. 15, 2005.

(51) Int. Cl. A01F 12/28

(52) U.S. Cl. 460/109

(57) ABSTRACT

A concave lifting device comprises a winch that can be fixedly supported on the frame of the combine in proximity to the concaves of the combine. A connector at a free end of the winch cable of the winch supports the concaves thereon. A single operator can thus conveniently raise the concaves into their in use position with minimal strain and without requiring any special tools. When the lifting device is arranged to mount on existing fasteners of the combine, no modification is required to the combine and installation can be easily accomplished with minimal effort as no mounting holes are required to be drilled.

This application is claims the benefit under 35 U.S.C. 119(e) of U.S. provisional application Ser. No. 60/651,497, filed Jun. 15, 2006.

### FIELD OF THE INVENTION

The present invention relates to a lifting device for lifting concaves within an agricultural combine relative to fixed components of the rotor assembly of the combine.

### BACKGROUND

Agricultural combines are known in the art for harvesting and threshing of crop materials. A typical combine reaps planted grain stocks and feeds the stocks to a separating apparatus which threshes and separates grain from other collected materials.

In a typical rotary combine, the separating apparatus includes a generally cylindrical threshing cage which rotatably supports a rotor therein for threshing the crop material between the rotor and the threshing cage as the rotor is rotated. A lower portion of the threshing cage includes a plurality of semi cylindrical concaves. The concaves are supported for movement relative to the upper portion of the cage and the rotor for adjusting the threshing operation depending upon different types of crop material received therein. It is also desirable to move the concaves to unplug the rotor or to perform certain repairs.

Once the concaves are lowered it is typically required that the concaves then be manually lifted by two or more operators using a crowbar or other leveraging tools. The awkward positioning of the concaves causes considerable strain on the operators lifting the concaves resulting in potential back injuries to the operators.

### SUMMARY OF THE INVENTION

According to one aspect of the invention there is provided, in a combine comprising: a frame and a rotor assembly comprising a threshing cage and rotor rotatable therein in which a portion of the threshing cage comprises semi-cylindrical concaves supported for movement generally radially relative to the rotor, a concave lifting device comprising:

a winch body;

a mounting bracket for supporting the winch body in fixed relationship to the frame of the combine;

a winch drum rotatably supported on the winch body;

a cable wound about the winch drum and including a connector at a free end thereof for supporting the concaves thereon;

a ratchet mechanism operable between the winch drum and the winch body; and

a crank arm connector mounted concentrically at one end of the drum for rotation with the drum.

The use of a lifting device which is particularly suited for mounting on a combine to lift the concaves relative to a fixed portion of the combine permits a single operator to raise the concaves into their in use position with minimal strain and without requiring any special tools. When the device is arranged to mount on existing fasteners of the combine, no modification is required to the combine and installation can be easily accomplished with minimal effort as no mounting holes are required to be drilled.

In one embodiment, the mounting bracket is secured to a fixed portion of the combine within an interior area defined by a housing of the combine. More particularly, the mounting bracket may be arranged for mounting on a fixed portion of the threshing cage. In each instance, the mounting bracket preferably includes mounting apertures therein which are suitably spaced for mounting onto existing threaded fasteners of the combine.

The connector at the free end of the cable preferably comprises a hook member. There may be provided a loop member mounted on an existing fastener of the concaves to assist in supporting the concaves on the hook member.

The crank arm connector may comprise a socket for mating engagement with a ratchet wrench.

According to a second aspect of the present invention, there is provided a combine upon which the lifting device is incorporated.

According to a further aspect of the present invention there is provided a concave lifting device for a combine comprising: a frame and a rotor assembly comprising a threshing cage and rotor rotatable therein in which a portion of the threshing cage comprises semi-cylindrical concaves supported for movement generally radially relative to the rotor, the device comprising:

a winch body;

a mounting bracket for supporting the winch body in fixed relationship to the frame of the combine, the mounting bracket including mounting apertures therein which are suitably spaced for mounting onto existing threaded fasteners of the combine;

a winch drum rotatably supported on the winch body;

a cable wound about the winch drum and including a connector at a free end thereof for supporting the concaves thereon, the connector comprising a hook member;

a ratchet mechanism operable between the winch drum and the winch body; and

a crank arm connector mounted concentrically at one end of the drum for rotation with the drum, the crank arm connector comprising a socket for mating engagement with a ratchet wrench.

According to another aspect of the present invention there is provided a method of lifting a concave in a combine comprising: a frame and a rotor assembly comprising a threshing cage and rotor rotatable therein in which a portion of the threshing cage comprises semi-cylindrical concaves supported for movement generally radially relative to the rotor, the method comprising:

providing a lifting device comprising a winch body; a winch drum rotatably supported on the winch body; a cable wound about the winch drum; and a ratchet mechanism operable between the winch drum and the winch body;

supporting the winch body on the combine in fixed relationship to the frame of the combine;

supporting the concaves on a free end of the cable; and

rotating the winch drum.

Some embodiments of the invention will now be described in conjunction with the accompanying drawings in which:

### BRIEF DESCRIPTION OF THE DRAWINGS

FIG. 1 is a perspective view of a combine upon which the lifting device is mounted.

FIG. 2 is a schematic rear elevational view of the lifting device in relation to various components of the combine.

FIG. 3 is an elevational view of the lifting device.

FIG. 4 is a schematic front elevational view of a second embodiment of the lifting device in relation to various components of the combine.

FIG. 5 is an elevational view of the lifting device according to the second embodiment.

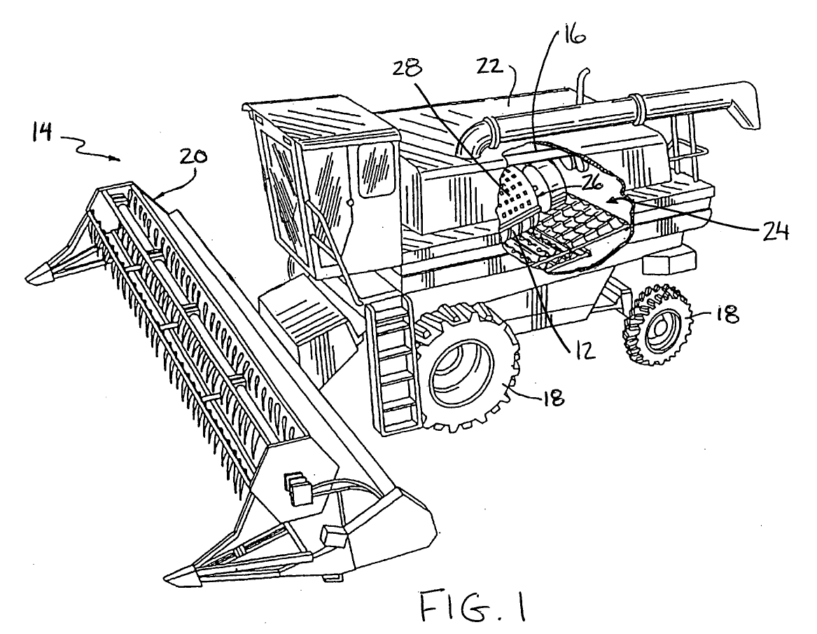

In the drawings like characters of reference indicate corresponding parts in the different figures.

### DETAILED DESCRIPTION

Referring to the accompanying figures there is illustrated a concave lifting device generally indicated by reference numeral 10. The device 10 is particularly suited for lifting the concaves 12 of a combine 14, for example various combine models commercially available by Case IH.

The combine 14 includes a frame 16 supported on wheels 18 for rolling movement in a forward working direction. A header 20 is mounted at a front end of the combine for reaping a planted crop. A housing 22 of the combine defines an interior area 24 enclosed within the housing.

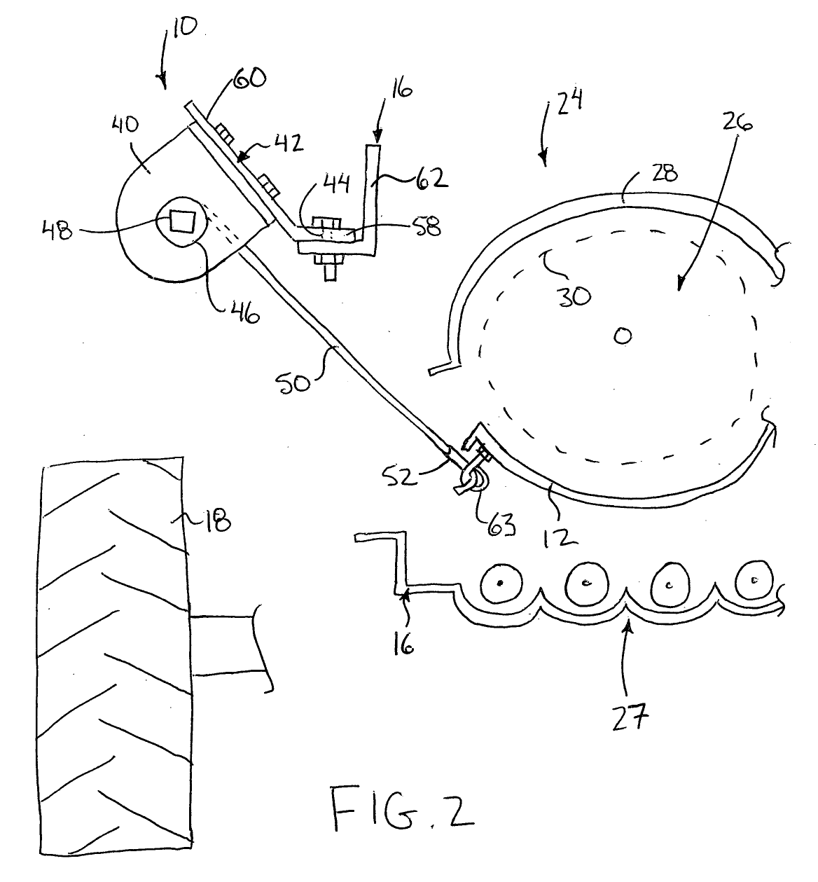

A rotor assembly 26 is supported within the interior area on the frame 16 of the combine. The assembly 26 includes a threshing cage 28 supporting a rotor 30 therein for rotation about a respective longitudinal axis to thresh the crop material between the rotor and the threshing cage. The threshing cage 28 is supported above an auger bed 27 as shown in FIG. 2.

A lower portion of the threshing cage 28 comprises a plurality of semi cylindrical concaves 12 against which the crop is threshed. The concaves 12 are supported for movement relative to the fixed upper portion of the cage and the fixed frame 16 of the combine for adjusting the spacing between the concave and the rotor which accordingly adjusts the threshing operation according to different crops and crop conditions. The concaves 12 can also be lowered from the upper portion of the threshing cage top to access the rotor for various cleaning, unplugging or repairing operations.

As shown in the accompanying figures, various embodiments of the lifting device are possible. The common elements of each will first be described herein.

The device 10 includes a winch body 40 including a mounting plate 42 locating bolt mounting apertures 44 therein. The bolt apertures 44 are suitably spaced for aligning with two spaced apart existing threaded fasteners on the combine.

The winch body 40 rotatably supports a winch drum 46 thereon. The winch drum 46 includes a socket 48 concentric with the drum at one end thereof which is suitably configured for connection with a ratchet wrench.

A cable 50 is anchored at an interior end on the drum 46 for being wound about the drum as the drum is rotated. A hook 52 is mounted at the free end of the cable 50 and is suitably arranged for supporting the concaves thereon to lift the concaves relative to the fixed portion of the combine frame.

A ratchet mechanism 54 is operatively connected between the winch drum 46 and the winch body 40 for selectively restricting rotation of the drum in one direction similar to conventional ratchet mechanisms.

The lifting device 10 is used by first mounting the mounting plate 42 of the winch body on a fixed portion of the combine by removing the nuts on a pair of existing threaded fasteners of the combine and subsequently reconnecting the nuts onto the threaded fasteners with the mounting plate 42 clamped therein. The cable 50 is unwound from the drum so that the hook 52 can be connected to the concaves. By using a suitable ratchet wrench 56 coupled to the socket 48, and with the ratchet mechanism 54 engaged, a single operator can safely lift the concaves in stages or alternatively lower the concaves in a controlled manner while suffering minimal strain.

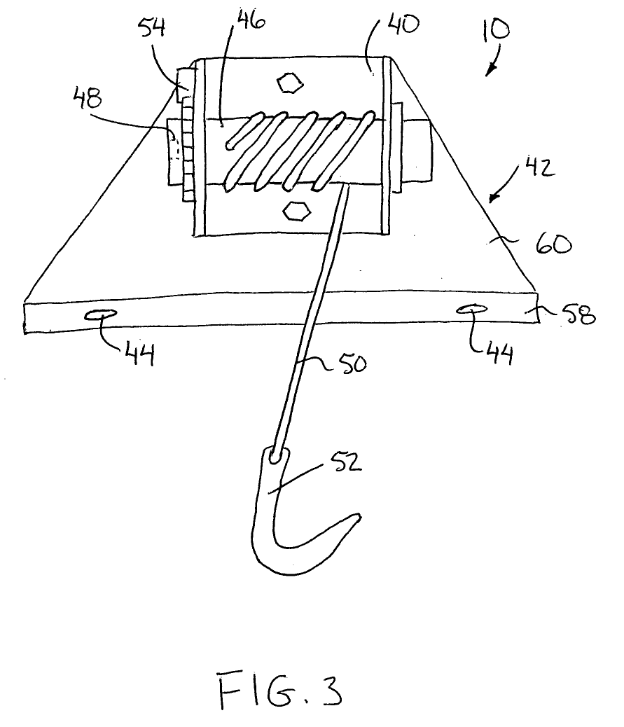

Turning now to FIGS. 2 and 3, a first embodiment of the lifting device will be described in further detail. The mounting plate in this instance includes a first flat portion 58 locating the bolt apertures 44 therein and a second portion 60 at an offset angle relative to the first portion which is also flat and which supports the winch body and winch drum thereon. The first portion of the mounting plate mounts to a fixed frame member 62 of the combine above an access panel into an interior area enclosed by the housing of the combine.

The device 10 operates in cooperation with a loop member 63 installed on the concaves in place of one of the existing fasteners of the concaves. The loop member includes a threaded shaft and nuts securable thereon for replacing an existing threaded bolt. The hook member is thus received in the loop member for supporting the

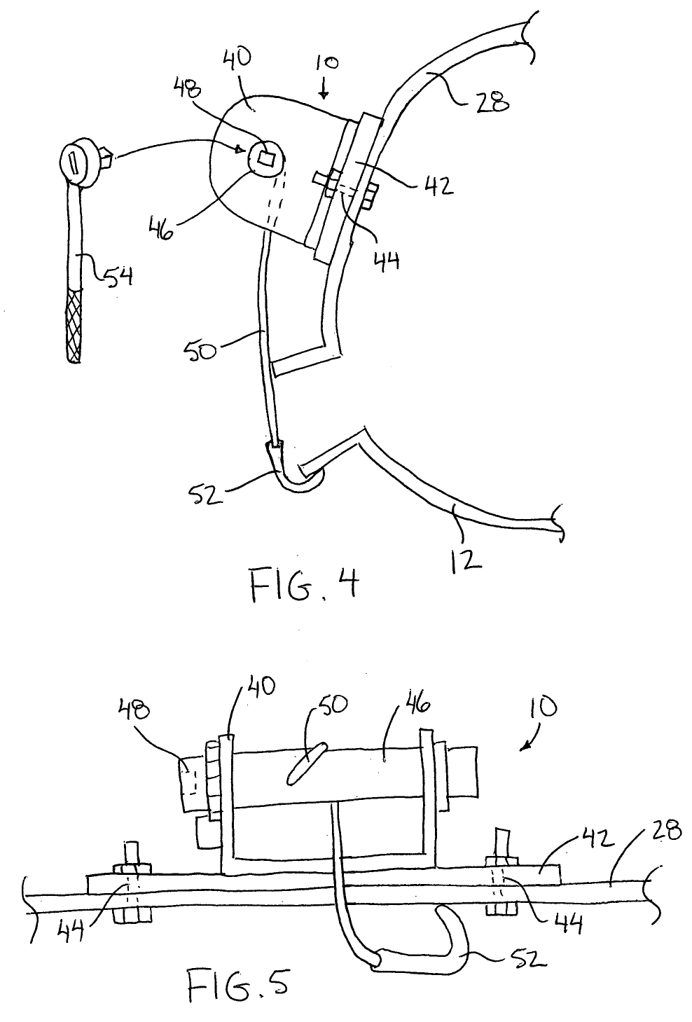

Turning now to FIGS. 4 and 5, the second embodiment is illustrated in which the mounting plate 42 is flat. The bolt apertures 44 are located in the plate spaced axially beyond the drum 46 at opposing ends of the drum. In order to install the lifting device according to the second embodiment, the access panel into the interior area within the combine is opened and the mounting plate is mounted onto existing threaded fasteners of the combine on a fixed portion of the threshing cage 28 above the concaves. The lifting device in this instance is fully housed within the interior area of the combine. In further embodiments, the lifting device may be secured to any other fixed beam or frame member within the interior area.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. In a combine comprising: a frame and a rotor assembly comprising a threshing cage and rotor rotatable therein in which a portion of the threshing cage comprises semi-cylindrical concaves supported for movement generally radially relative to the rotor, a concave lifting device comprising:
a winch body;
a mounting bracket for supporting the winch body in fixed relationship to the frame of the combine;
a winch drum rotatably supported on the winch body;
a cable wound about the winch drum and including a connector at a free end thereof for supporting the concaves thereon;
a ratchet mechanism operable between the winch drum and the winch body; and
a crank arm connector mounted concentrically at one end of the drum for rotation with the drum.

2. The device according to claim 1 wherein the mounting bracket is secured to a fixed portion of the combine within an interior area defined by a housing of the combine.

3. The device according to claim 1 wherein the mounting bracket includes mounting apertures therein which are suitably spaced for mounting onto existing threaded fasteners of the combine.

4. The device according to claim 1 wherein the mounting bracket is arranged for mounting on a fixed portion of the threshing cage.

5. The device according to claim 1 wherein the connector at the free end of the cable comprises a hook member.

6. The device according to claim 1 wherein the crank arm connector comprises a socket for mating engagement with a ratchet wrench.

7. The device according to claim 1 wherein there is provided a loop member mounted on an existing fastener of the concaves.

8. The device according to claim 1 in combination with the combine.

9. A concave lifting device for a combine comprising: a frame and a rotor assembly comprising a threshing cage and rotor rotatable therein in which a portion of the threshing cage comprises semi-cylindrical concaves supported for movement generally radially relative to the rotor, the device comprising:
a winch body;
a mounting bracket for supporting the winch body in fixed relationship to the frame of the combine, the mounting bracket including mounting apertures therein which are suitably spaced for mounting onto existing threaded fasteners of the combine;
a winch drum rotatably supported on the winch body;
a cable wound about the winch drum and including a connector at a free end thereof for supporting the concaves thereon, the connector comprising a hook member;
a ratchet mechanism operable between the winch drum and the winch body; and
a crank arm connector mounted concentrically at one end of the drum for rotation with the drum, the crank arm connector comprising a socket for mating engagement with a ratchet wrench.

10. The device according to claim 9 wherein the mounting bracket is secured to a fixed portion of the combine within an interior area defined by a housing of the combine.

11. The device according to claim 9 wherein the mounting bracket is arranged for mounting on a fixed portion of the threshing cage.

12. A method of lifting a concave in a combine comprising: a frame and a rotor assembly comprising a threshing cage and rotor rotatable therein in which a portion of the threshing cage comprises semi-cylindrical concaves supported for movement generally radially relative to the rotor, the method comprising:
providing a lifting device comprising a winch body; a winch drum rotatably supported on the winch body; a cable wound about the winch drum; and a ratchet mechanism operable between the winch drum and the winch body;
supporting the winch body on the combine in fixed relationship to the frame of the combine;
supporting the concaves on a free end of the cable; and
rotating the winch drum.

13. The method according to claim 12 including securing the winch body to a fixed portion of the combine within an interior area defined by a housing of the combine.

14. The method according to claim 12 including mounting the winch body onto existing threaded fasteners of the combine.

15. The method according to claim 12 including securing the winch body onto a fixed portion of the threshing cage.

16. The method according to claim 12 including providing a hook member at the free end of the cable for supporting the concaves thereon.

17. The method according to claim 12 including provided a socket at one end of the winch drum for rotation therewith and matingly engaging a ratchet wrench with the socket to rotate the drum.

18. The method according to claim 12 including mounting a loop member on an existing fastener of the concaves and connecting the free end of the cable to the loop member.
